(19) United States
(12) Patent Application Publication
(10) Pub. No.: US 2014/0356531 A1
(43) Pub. Date: Dec. 4, 2014

(54) FILM FORMATION APPARATUS AND FILM FORMATION METHOD

(71) Applicant: KABUSHIKI KAISHA TOSHIBA, Minato-ku (JP)

(72) Inventors: Tsuyoshi SATO, Kanagawa-ken (JP); Toshiyuki Kishi, Kanagawa-ken (JP)

(73) Assignee: KABUSHIKI KAISHA TOSHIBA, Minato-ku (JP)

(21) Appl. No.: 14/197,632

(22) Filed: Mar. 5, 2014

(30) Foreign Application Priority Data
May 31, 2013 (JP) 2013-115277

(51) Int. Cl. B05C 11/08; B05D 3/12

(52) U.S. Cl. CPC B05C 11/08; B05D 3/12
USPC 427/240; 118/52; 118/704; 118/642

(57) ABSTRACT

According to one embodiment, a film formation apparatus is configured to coat a processing fluid on a surface of a substrate by supplying the fluid to the surface of the substrate from a nozzle while rotating the substrate and moving the nozzle and configured to form a film from the coated fluid by rotating the substrate. The apparatus includes: a holder configured to hold the substrate; a drive unit configured to rotate the holder; a processing fluid supply unit configured to supply the processing fluid onto the surface of the substrate held by the holder; and a controller configured to control at least the drive unit. The controller is configured to form the film from the coated processing fluid by rotating the holder at a second rotational speed, the second rotational speed being slower than a first rotational speed of the coating of the processing fluid.

### CROSS-REFERENCE TO RELATED APPLICATIONS

This application is based upon and claims the benefit of priority from Japanese Patent Application No. 2013-115277, filed on May 31, 2013; the entire contents of which are incorporated herein by reference.

### FIELD

Embodiments described herein relate generally to a film formation apparatus and film formation method.

### BACKGROUND

There is technology for forming a film by supplying a processing fluid to the surface of a rotating substrate from a nozzle while moving the nozzle from the center of the substrate toward the outer circumferential edge of the substrate to coat the processing fluid in a spiral configuration on the surface of the substrate, and subsequently rotating the substrate at a rotational speed that is faster than the rotational speed of the coating of the processing fluid to form the film from the coated processing fluid.

The film thickness can be made uniform using such technology.

However, in the case where the substrate is rotated at a rotational speed that is faster than the rotational speed of the coating of the processing fluid after the completion of the coating of the processing fluid, a portion of the processing fluid scatters at the surface of the substrate; and the utilization efficiency of the processing fluid decreases.

Therefore, it is desirable to develop technology that can increase the utilization efficiency of the processing fluid and make the film thickness uniform.

### BRIEF DESCRIPTION OF THE DRAWINGS

FIG. 1 is a schematic cross-sectional view showing a film formation apparatus according to an embodiment;

FIG. 2 is a schematic plan view showing the film formation apparatus according to the embodiment;

FIG. 3 is a schematic view showing the supply of a processing fluid and a configuration of the coated processing fluid at a surface of a substrate;

FIG. 4 is a schematic view showing a state of a film according to a comparative example;

FIG. 5 is a schematic view showing a state of a film according to a comparative example; and

FIG. 6 is a flowchart showing effects of the film formation apparatus and the film formation method.

### DETAILED DESCRIPTION

In general, according to one embodiment, a film formation apparatus is configured to coat a processing fluid in a spiral configuration on a surface of a substrate by supplying the processing fluid to the surface of the substrate from a nozzle while rotating the substrate and moving the nozzle and configured to form a film from the coated processing fluid by rotating the substrate. The apparatus includes: a holder configured to hold the substrate; a drive unit configured to rotate the holder; a processing fluid supply unit configured to supply the processing fluid onto the surface of the substrate held by the holder; and a controller configured to control at least the drive unit. The controller is configured to form the film from the coated processing fluid by rotating the holder at a second rotational speed, the second rotational speed being slower than a first rotational speed of the coating of the processing fluid.

Embodiments will now be described with reference to the drawings. Similar components in the drawings are marked with like reference numerals, and a detailed description is omitted as appropriate.

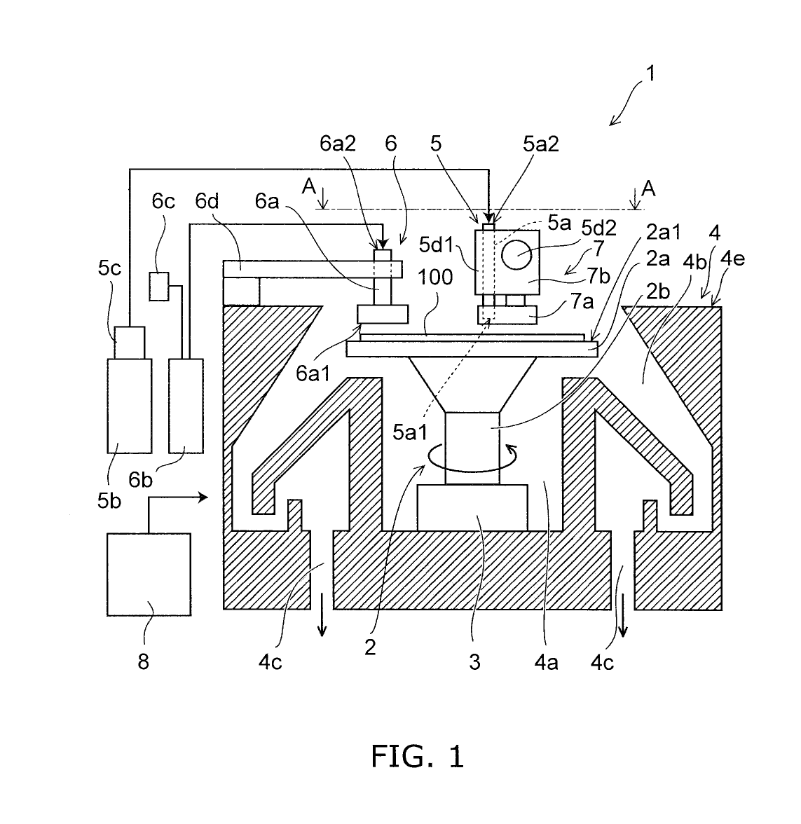

FIG. 1 is a schematic cross-sectional view showing a film formation apparatus 1 according to the embodiment.

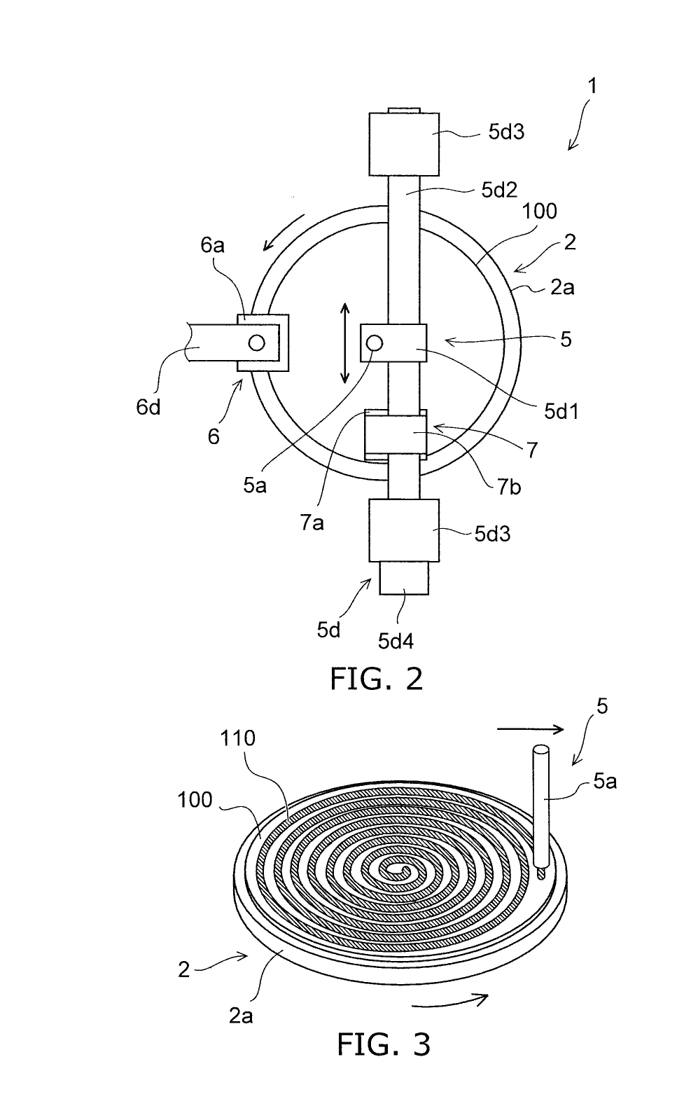

FIG. 2 is a schematic plan view showing the film formation apparatus 1 according to the embodiment.

FIG. 2 is a line A-A fragmentary view of FIG. 1.

FIG. 3 is a schematic view showing the supply of a processing fluid 110 and the configuration of the coated processing fluid 110 at the surface of a substrate 100.

As shown in FIG. 1 and FIG. 2, a holder 2, a drive unit 3, a cup 4, a processing fluid supply unit 5, a first liquidity controller 6, a second liquidity controller 7, and a controller 8 are provided in the film formation apparatus 1.

The holder 2 receives the substrate 100 that is placed and holds the substrate 100 that is placed.

The holder 2 is provided in the interior of the cup 4. The holder 2 includes a placement unit 2a and an axial unit 2b.

The placement unit 2a has a disc configuration; and one surface of the placement unit 2a is a placement surface 2a1 on which the substrate 100 is placed. The placement unit 2a holds the substrate 100 that is placed on the placement surface 2a1. The substrate 100 may be held by, for example, suction using a not-shown vacuum pump, etc.

One end portion of the axial unit 2b is provided at a surface of the placement unit 2a on the side opposite to the placement surface 2a1. One other end portion of the axial unit 2b is connected to the drive unit 3.

The drive unit 3 rotates the holder 2.

The drive unit 3 is provided in the interior of the cup 4. The drive unit 3 may include, for example, a control motor such as a servo motor, etc., that can change the rotational speed.

The cup 4 is provided around at least the periphery of the holder 2.

The cup 4 suppresses the scattering outside the film formation apparatus 1 of the processing fluid 110 coated onto the surface of the substrate 100.

The cup 4 has a space 4a; and the holder 2 is provided at the central portion of the space 4a. A space 4b that is tilted toward the bottom portion of the cup 4 is provided outward from the space 4a. The space 4a and the space 4b are open at the top. An upper surface 4e of the cup 4 is positioned to be higher than the surface (the upper surface) of the substrate 100 placed on the placement unit 2a.

An outlet 4c is provided at the bottom portion of the cup 4. The outlet 4c is connected to a not-shown recovery unit. The processing fluid 110 that is discharged from the substrate 100 is guided to the bottom portion of the cup 4 via the space 4b and recovered by the not-shown recovery unit via the outlet 4c.

The processing fluid supply unit 5 supplies the processing fluid 110 to the surface of the substrate 100 that is held by the holder 2 and rotated.

In such a case, as shown in FIG. 3, the processing fluid 110 is supplied from a nozzle 5a to the surface of the rotating substrate 100 while the nozzle 5a is moved from the center of the substrate 100 toward the outer circumferential edge of the substrate 100. Thereby, the processing fluid 110 is coated in a spiral configuration on the surface of the substrate 100.

The processing fluid supply unit 5 includes the nozzle 5a, a container 5b, a supply unit 5c, and a moving unit 5d.

A dispensing aperture 5a1 is provided at one end of the nozzle 5a; and a supply port 5a2 is provided at the other end of the nozzle 5a.

The container 5b contains the processing fluid 110.

The processing fluid 110 may be, for example, a photoresist liquid, etc.

The supply unit 5c supplies the processing fluid 110 contained in the container 5b to the surface of the substrate 100 via the nozzle 5a. The supply unit 5c may include, for example, a pump, a flow regulating valve, etc.

The moving unit 5d includes a holder 5d1, an axial unit 5d2, support units 5d3, and a drive unit 5d4.

The holder 5d1 is provided on the axial unit 5d2 to move along the axial unit 5d2. The holder 5d1 holds the nozzle 5a such that the dispensing aperture 5a1 side is oriented toward the placement unit 2a.

The axial unit 5d2 is provided to cross above the placement surface 2a1.

The support units 5d3 are provided at two ends of the axial unit 5d2. The support units 5d3 may be provided at the upper surface 4e of the cup 4, etc.

The drive unit 5d4 is connected to one end portion of the axial unit 5d2.

The moving unit 5d changes the position of the nozzle 5a held by the holder 5d1.

For example, the holder 5d1 may be a nut; the axial unit 5d2 may be a ball screw; and the drive unit 5d4 may be a control motor such as a servo motor, etc.

The first liquidity controller 6 controls the liquidity of a film 120 formed from the coated processing fluid 110 to be high at a region proximal to the outer circumferential edge of the substrate 100.

The second liquidity controller 7 controls the liquidity of the film 120 formed from the coated processing fluid 110 to be low.

The details of the first liquidity controller 6 and the second liquidity controller 7 are described below.

The controller 8 controls the operations of the components provided in the film formation apparatus 1.

The controller 8 performs, for example, the control of the substrate 100 being held by the placement unit 2a, the control of the rotational speed of the holder 2 (the control of the rotational speed of the substrate 100) by the drive unit 3, the control of the supply of the processing fluid 110 by the supply unit 5c, the positional control of the nozzle 5a by the drive unit 5d4, the control of the supply of a solvent by a supply unit 6c, the control of the evaporation of the solvent by a drying unit 7a, the positional control of the drying unit 7a by the drive unit 5d4, etc.

The state of the film 120 formed from the processing fluid 110 according to a comparative example will now be described.

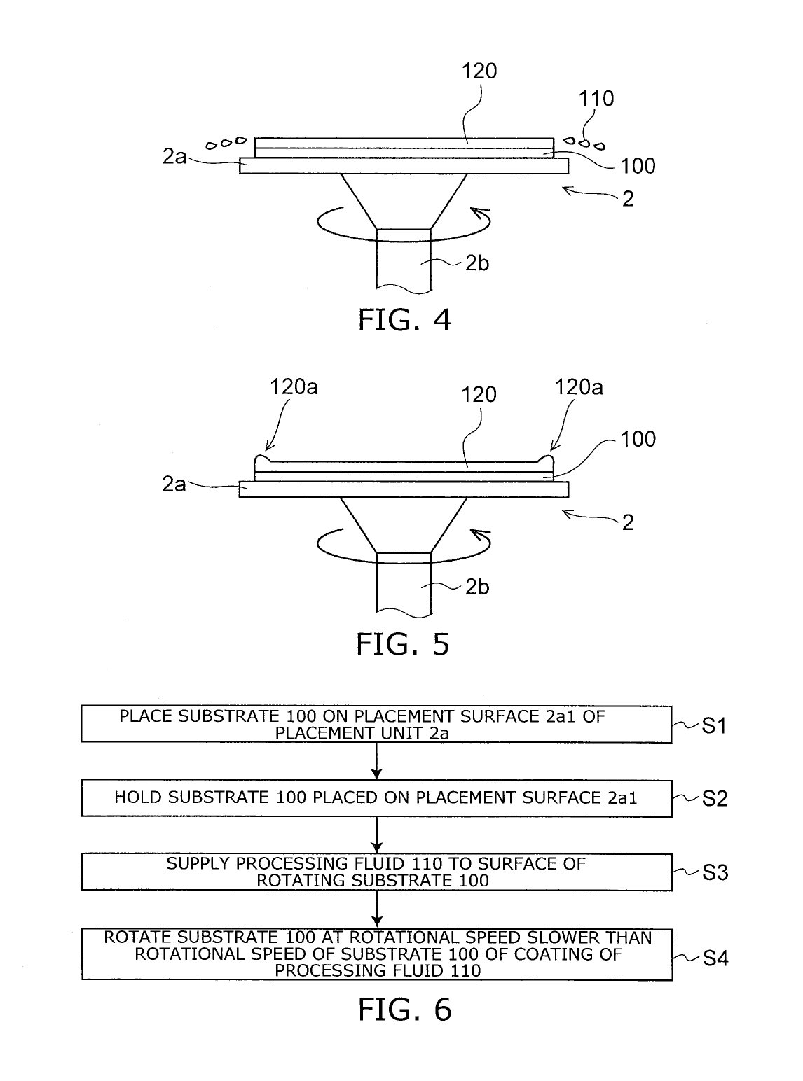

FIG. 4 and FIG. 5 are schematic views showing the state of the film 120 according to the comparative example.

First, when forming the film 120 on the surface of the substrate 100 as shown in FIG. 3, the processing fluid 110 is supplied to the surface of the rotating substrate 100 from the nozzle 5a while moving the nozzle 5a from the center of the substrate 100 toward the outer circumferential edge of the substrate 100.

Thereby, the processing fluid 110 is coated in a spiral configuration on the surface of the substrate 100.

Then, the substrate 100 is rotated at a rotational speed that is faster than the rotational speed of the coating of the processing fluid 110.

Thus, the processing fluid 110 that is coated in the spiral configuration on the surface of the substrate 100 spreads outward on the substrate 100; and the film 120 can be formed from the processing fluid 110 with a uniform film thickness.

However, when the substrate 100 is rotated at the rotational speed that is faster than the rotational speed of the coating of the processing fluid 110 as shown in FIG. 4, a portion of the processing fluid 110 scatters at the surface of the substrate 100; and the utilization efficiency of the processing fluid 110 decreases.

In such a case, the film 120 can be formed by maintaining the rotational speed of the substrate 100 of the coating of the processing fluid 110 after coating the processing fluid 110.

Thus, the utilization efficiency of the processing fluid 110 can be increased because the amount of the processing fluid 110 that scatters can be reduced.

However, because the film 120 has liquidity before completely curing, the processing fluid 110 easily collects proximally to the outer circumferential edge of the substrate 100 due to the rotation of the substrate 100.

Therefore, as shown in FIG. 5, a portion 120a where the film 120 swells is formed easily above the outer circumferential edge vicinity of the substrate 100.

That is, if the rotational speed of the substrate 100 of the coating of the processing fluid 110 is maintained even after coating the processing fluid 110, the utilization efficiency of the processing fluid 110 can be increased; but it is difficult to make the film thickness of the film 120 uniform.

In such a case, because the swelled portion 120a forms more easily as the liquidity of the film 120 increases, it is more difficult to make the film thickness of the film 120 uniform.

For example, in the case where the processing fluid 110 is a photoresist liquid, etc., it is extremely difficult to make the film thickness of the film 120 uniform because the liquidity of the film 120 is high.

Therefore, in the film formation apparatus 1 according to the embodiment, the utilization efficiency of the processing fluid 110 is increased and the film thickness of the film 120 is made uniform by appropriately switching the rotational speed of the substrate 100.

For example, the controller 8 rotates the holder 2 at a second rotational speed that is slower than a first rotational speed of the coating of the processing fluid 110 to form the film 120 from the coated processing fluid 110.

Thus, the portion of the processing fluid 110 that collects proximally to the outer circumferential edge of the substrate 100 due to the rotation of the substrate 100 can be moved toward the center of the substrate 100. In other words, by moving the portion of the processing fluid 110 that collects proximally to the outer circumferential edge of the substrate 100 toward the center of the substrate 100, the formation of the swelled portion 120a shown in FIG. 5 can be suppressed.

Also, the amount of the scattered processing fluid 110 can be reduced further by reducing the rotational speed to be lower than the first rotational speed of the substrate 100 of the coating of the processing fluid 110.

Therefore, the utilization efficiency of the processing fluid 110 can be increased; and the film thickness of the film 120 can be made uniform.

There are cases where the rotational speed of the substrate 100 is changed when supplying the processing fluid 110.

For example, there are cases where the rotational speed of the substrate 100 is increased or reduced as the position of the nozzle 5a changes from the center of the substrate 100 toward the outer circumferential edge of the substrate 100.

In such a case, it is sufficient to rotate the substrate 100 at the second rotational speed that is slower than the maximum rotational speed when supplying the processing fluid 110.

Also, the controller 8 may rotate the holder 2 at the third rotational speed after rotating the holder 2 at the second rotational speed, where the third rotational speed is faster than the second rotational speed.

Thus, the portion of the processing fluid 110 that collects proximally to the outer circumferential edge of the substrate 100 can be moved toward the center of the substrate 100; and subsequently, the portion of the processing fluid 110 that moved toward the center of the substrate 100 can be moved toward the outer circumferential edge of the substrate 100.

Therefore, because the processing fluid 110 can be made uniform by being moved, the film thickness of the film 120 can be made more uniform.

The third rotational speed may be the same as or different from the first rotational speed.

Further, the controller 8 may rotate the holder 2 by sequentially switching between the third rotational speed and the fourth rotational speed after rotating the holder 2 at the second rotational speed, where the third rotational speed is faster than the second rotational speed, and the fourth rotational speed is slower than the third rotational speed.

Thus, a portion of the processing fluid 110 can be moved repeatedly between the outer circumferential edge of the substrate 100 and the center of the substrate 100.

Therefore, the film thickness of the film 120 can be made more uniform.

The fourth rotational speed may be the same as or different from the second rotational speed.

In the case where the switching between the third rotational speed and the fourth rotational speed is multiply performed, the third rotational speed may be the same or different between the switching. Also, the fourth rotational speed may be the same or different between the switching.

Here, the movement state of the processing fluid 110 is affected by the viscosity of the processing fluid 110, the thermosetting properties of the processing fluid 110, the amount of the processing fluid 110, the size of the substrate 100, environmental conditions such as temperature, etc.

However, the appropriate values of the rotational speed, the maintaining time of the rotational speed, the number of rotational speed switches, etc., of the substrate 100 may be determined by performing experiments and/or simulations beforehand.

The first liquidity controller 6 will now be described further.

As shown in FIG. 1 or FIG. 2, the first liquidity controller 6 includes a nozzle 6a, a container 6b, the supply unit 6c, and a holder 6d.

A dispensing aperture 6a1 is provided at one end of the nozzle 6a; and a supply port 6a2 is provided at the other end of the nozzle 6a. The nozzle 6a sprays the solvent supplied by the supply unit 6c in a mist.

The container 6b contains the solvent. The solvent may be, for example, the same solvent that is included in the processing fluid 110. In the case where the processing fluid 110 is a photoresist liquid, the solvent may be, for example, a ketone solvent, an alcohol solvent, etc.

The supply unit 6c supplies the solvent contained in the container 6b to a region of the film 120 proximal to the outer circumferential edge of the substrate 100 via the nozzle 6a. The supply unit 6c may be, for example, a unit that supplies a nitrogen gas, etc., to the container 6b. By the nitrogen gas, etc., being supplied to the container 6b by the supply unit 6c, the solvent contained in the container 6b is forced toward the nozzle 6a. The holder 6d holds the nozzle 6a above the outer circumferential edge vicinity of the substrate 100 with the dispensing aperture 6a1 side oriented toward the placement unit 2a. The holder 6d is provided at the upper surface 4e of the cup 4.

The first liquidity controller 6 supplies the solvent to the region of the film 120 proximal to the outer circumferential edge of the substrate 100.

By supplying the solvent to the region of the film 120 proximal to the outer circumferential edge of the substrate 100, the liquidity of the film 120 in the region can be increased.

Therefore, the film thickness of the film 120 can be made uniform because the formation of the swelled portion 120a shown in FIG. 5 can be suppressed.

The second liquidity controller 7 will now be described further.

As shown in FIG. 1 or FIG. 2, the second liquidity controller 7 includes the drying unit 7a and a holder 7b.

The drying unit 7a reduces the liquidity of the film 120 by evaporating the solvent included in the film 120. The drying unit 7a may be, for example, an infrared heater, a forced air heater, etc. In such a case, there is a risk that the uniformity of the film thickness may degrade if an external force is applied to the film 120. Therefore, it is favorable for the drying unit 7a to be a unit such as an infrared heater, etc., that does not apply an external force to the film 120.

The holder 7b is provided on the axial unit 5d2 to move along the axial unit 5d2. Also, the holder 7b holds the drying unit 7a above the placement unit 2a.

The holder 7b is moved along the axial unit 5d2 by the axial unit 5d2, the support units 5d3, and the drive unit 5d4.

Because the time period of use is different between the processing fluid supply unit 5 and the second liquidity controller 7, the processing fluid supply unit 5 and the second liquidity controller 7 both can use the axial unit 5d2, the support units 5d3, and the drive unit 5d4. The processing fluid supply unit 5 and the second liquidity controller 7 may be provided on separate axial units 5d2, support units 5d3, and drive units 5d4. However, the mechanisms can be simple and compact if the processing fluid supply unit 5 and the second liquidity controller 7 use the same axial unit 5d2, support units 5d3, and drive unit 5d4.

Here, there are cases where the film 120 formed on the surface of the substrate 100 is not completely cured. Therefore, there are cases where the film 120 is completely cured by drying in a subsequent process by a bake oven, etc.

In such a case, if the liquidity of the film 120 is still relatively high, there is a risk that the film 120 may deform and the uniformity of the film thickness may degrade when transferring the substrate 100 from the film formation apparatus 1 to the bake oven, etc.

Therefore, in the film formation apparatus 1 according to the embodiment, the liquidity of the film 120 can be reduced by providing the second liquidity controller 7.

Then, the degradation of the uniformity of the film thickness due to the deformation of the film 120 can be suppressed by reducing the liquidity of the film 120.

The drying unit 7a moves in a prescribed direction above the placement surface 2a1 (the substrate 100). Therefore, by rotating the substrate 100 and moving the drying unit 7a, the liquidity in a designated region of the film 120 formed on the surface of the substrate 100 can be reduced; and the liquidity in the entire region of the film 120 can be reduced.

Effects of the film formation apparatus 1 and a film formation method according to the embodiment will now be described.

FIG. 6 is a flowchart showing effects of the film formation apparatus 1 and the film formation method.

As shown in FIG. 6, first, the substrate 100 is placed on the placement surface 2a1 of the placement unit 2a by a not-shown transfer apparatus, etc. (step S1).

Then, the substrate 100 that is placed on the placement surface 2a1 is held by suction, etc., using a not-shown vacuum pump, etc. (step S2).

Continuing, the processing fluid 110 is supplied to the surface of the rotating substrate 100 (step S3).

First, the controller 8 controls the drive unit 3 to rotate the holder 2 at the first rotational speed.

Continuing, the processing fluid 110 is supplied to the surface of the rotating substrate 100 from the nozzle 5a while moving the nozzle 5a from the center of the substrate 100 toward the outer circumferential edge of the substrate 100.

Thereby, as shown in FIG. 3, the processing fluid 110 is coated in a spiral configuration on the surface of the substrate 100.

Then, the substrate 100 is rotated at a rotational speed that is slower than the rotational speed of the substrate 100 of the coating of the processing fluid 110 (step S4).

Namely, the controller 8 controls the drive unit 3 to rotate the holder 2 at the second rotational speed that is slower than the first rotational speed of the coating of the processing fluid 110.

The film 120 can be formed from the processing fluid 110 that is coated in the spiral configuration by rotating the holder 2 that holds the substrate 100.

Also, a portion of the processing fluid 110 that collects proximally to the outer circumferential edge of the substrate 100 can be moved toward the center of the substrate 100 by rotating the holder 2 at the second rotational speed that is slower than the first rotational speed of the coating of the processing fluid 110. Therefore, the formation of the swelled portion 120a shown in FIG. 5 can be suppressed.

Further, the amount of the scattered processing fluid 110 can be reduced by rotating the holder 2 at the second rotational speed that is slower than the first rotational speed of the coating of the processing fluid 110.

Therefore, the utilization efficiency of the processing fluid 110 can be increased; and the film thickness of the film 120 can be made uniform.

As described above, the controller 8 may rotate the holder 2 at the third rotational speed after rotating the holder 2 at the second rotational speed, where the third rotational speed is faster than the second rotational speed.

Also, the controller 8 may rotate the holder 2 by sequentially switching between the third rotational speed and the fourth rotational speed after rotating the holder 2 at the second rotational speed, where the third rotational speed is faster than the second rotational speed, and the fourth rotational speed is slower than the third rotational speed.

Further, the following processing may be performed as necessary.

For example, the liquidity of the film 120 may be controlled to be high in the region proximal to the outer circumferential edge of the substrate 100.

For example, the solvent is sprayed in a mist from the nozzle 6a toward the region of the film 120 proximal to the outer circumferential edge of the substrate 100. The liquidity of the film 120 in the region is increased by the sprayed solvent. Therefore, the swelled portion 120a does not form easily in the film 120.

For example, after the completion of making the film thickness uniform, the liquidity of the film 120 may be controlled to be low.

In such a case, first, the substrate 100 (the holder 2) is rotated at a prescribed rotational speed by the drive unit 3.

Continuing, the moving unit 5d causes the position of the drying unit 7a to move while the drying unit 7a is operated. For example, the position of the drying unit 7a may be moved from the center of the substrate 100 toward the outer circumferential edge of the substrate 100; the position of the drying unit 7a may be moved from the outer circumferential edge of the substrate 100 toward the center of the substrate 100; or the position of the drying unit 7a may be moved back and forth between the center of the substrate 100 and the outer circumferential edge of the substrate 100.

The liquidity of the film 120 can be reduced because the solvent included in the film 120 can be evaporated by the drying unit 7a. Also, the liquidity of the film 120 can be reduced in the entire region of the film 120 or in a designated region of the film 120 by moving the position of the drying unit 7a while rotating the substrate 100.

In such a case, the liquidity of the film 120 can be caused to be such that the degradation of the uniformity of the film thickness due to the deformation of the film 120 can be prevented when transferring the substrate 100, etc.

The liquidity of the film 120 can be controlled by the operation conditions (for example, the temperature, movement speed, etc.) of the drying unit 7a, the rotational speed of the substrate 100, etc.

Here, the operation conditions of the drying unit 7a, the rotational speed of the substrate 100, etc., are affected by the type of the solvent, the necessary liquidity of the film 120, etc.

However, the appropriate values of the operation conditions of the drying unit 7a, the rotational speed of the substrate 100, etc., may be determined by performing experiments and/or simulations beforehand.

Then, the substrate 100 on which the film 120 is formed is extracted from the film formation apparatus 1 by a not-shown transfer apparatus, etc.

The extracted substrate 100 may be dried further by a bake oven, etc.

In such a case, by controlling the liquidity of the film 120 to be low after the completion of making the film thickness uniform, the degradation of the uniformity of the film thickness due to the deformation of the film 120 can be suppressed when transferring the substrate 100 from the film formation apparatus 1 to the bake oven, etc.

A method for manufacturing an electronic device using the film formation apparatus 1 or the film formation method according to the embodiment will now be described.

For example, a method for manufacturing a semiconductor device may be illustrated as the method for manufacturing the electronic device. Here, the manufacturing processes of the semiconductor device include the so-called front-end processes such as the processes that form patterns in the substrate (wafer) surface by film formation, resist coating, exposing, developing, etching, resist removal, etc., and the inspection processes, cleaning processes, heat treatment processes, impurity introduction processes, diffusion processes, planarizing processes, etc. The so-called back-end processes include assembly processes such as dicing, mounting, bonding, encapsulation, etc., inspection processes that perform inspections of the functions and/or the reliability, etc.

The film formation apparatus 1 or the film formation method according to the embodiment is used in, for example, a resist coating process, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A film formation apparatus configured to coat a processing fluid in a spiral configuration on a surface of a substrate by supplying the processing fluid to the surface of the substrate from a nozzle while rotating the substrate and moving the nozzle and configured to form a film from the coated processing fluid by rotating the substrate, the apparatus comprising:
a holder configured to hold the substrate;
a drive unit configured to rotate the holder;
a processing fluid supply unit configured to supply the processing fluid onto the surface of the substrate held by the holder; and
a controller configured to control at least the drive unit,
the controller being configured to form the film from the coated processing fluid by rotating the holder at a second rotational speed, the second rotational speed being slower than a first rotational speed of the coating of the processing fluid.

2. The apparatus according to claim 1, wherein the controller is configured to rotate the holder at a third rotational speed after rotating the holder at the second rotational speed, the third rotational speed being faster than the second rotational speed.

3. The apparatus according to claim 1, wherein the controller is configured to rotate the holder by sequentially switching between a third rotational speed and a fourth rotational speed after rotating the holder at the second rotational speed, the third rotational speed being faster than the second rotational speed, the fourth rotational speed being slower than the third rotational speed.

4. The apparatus according to claim 1, further comprising a first liquidity controller configured to control a liquidity of the film formed from the coated processing fluid to be high at a region proximal to an outer circumferential edge of the substrate.

5. The apparatus according to claim 1, further comprising a cup provided around at least a periphery of the holder.

6. The apparatus according to claim 1, further comprising a second liquidity controller configured to control a liquidity of the film formed from the coated processing fluid to be low.

7. The apparatus according to claim 1, wherein
the processing fluid supply unit includes a nozzle configured to dispense the processing fluid, a moving unit configured to change a position of the nozzle, and a supply unit configured to supply the processing fluid to the nozzle, and
the controller controls the drive unit, the moving unit, and the supply unit to supply the processing fluid onto the surface of the rotating substrate from the nozzle while moving the nozzle from a center of the substrate toward an outer circumferential edge of the substrate.

8. The apparatus according to claim 7, wherein the processing fluid is coated in the spiral configuration on the surface of the substrate by supplying the processing fluid onto the surface of the rotating substrate from the nozzle.

9. The apparatus according to claim 1, wherein the controller is configured to cause a portion of the processing fluid collecting proximally to an outer circumferential edge of the substrate to move toward a center of the substrate by rotating the holder at the second rotational speed, the second rotational speed being slower than the first rotational speed of the coating of the processing fluid.

10. The apparatus according to claim 2, wherein the controller is configured to cause a portion of the processing fluid collecting proximally to an outer circumferential edge of the substrate to move toward a center of the substrate by rotating the holder at the third rotational speed after rotating the holder at the second rotational speed and subsequently cause a portion of the processing fluid having moved toward the center of the substrate to move toward the outer circumferential edge of the substrate, the third rotational speed being faster than the second rotational speed.

11. The apparatus according to claim 3, wherein the controller is configured to cause a portion of the processing fluid to move repeatedly between an outer circumferential edge of the substrate and a center of the substrate after rotating the holder at the second rotational speed by rotating the holder by sequentially switching between the third rotational speed and the fourth rotational speed, the third rotational speed being faster than the second rotational speed, the fourth rotational speed being slower than the third rotational speed.

12. The apparatus according to claim 7, wherein the controller is configured to change a rotational speed of the substrate according to the change of the position of the nozzle.

13. The apparatus according to claim 4, wherein the first liquidity controller is configured to supply a solvent to the region.

14. The apparatus according to claim 6, wherein the second liquidity controller includes a drying unit configured to evaporate a solvent included in the film.

15. The apparatus according to claim 14, wherein the drying unit is at least one selected from an infrared heater and a forced air heater.

16. The apparatus according to claim 1, wherein the processing fluid is a photoresist liquid.

17. A film formation method including coating a processing fluid in a spiral configuration on a surface of a substrate by supplying the processing fluid to the surface of the substrate from a nozzle while rotating the substrate and moving the nozzle and including forming a film from the coated processing fluid by rotating the substrate, the method comprising:
forming the film from the coated processing fluid by rotating the substrate at a second rotational speed, the second rotational speed being slower than a first rotational speed of the coating of the processing fluid.

18. The method according to claim 17, including rotating the substrate at a third rotational speed after rotating the substrate at the second rotational speed, the third rotational speed being faster than the second rotational speed.

19. The method according to claim 17, including rotating the substrate by sequentially switching between a third rotational speed and a fourth rotational speed after rotating the substrate at the second rotational speed, the third rotational speed being faster than the second rotational speed, the fourth rotational speed being slower than the third rotational speed.

20. The method according to claim 17, including supplying a solvent to the region to cause a liquidity of the film formed from the coated processing fluid to be high in a region proximal to an outer circumferential edge of the substrate.
